(19) United States
(12) Patent Application Publication
(10) Pub. No.: US 2005/0091551 A1
(43) Pub. Date: Apr. 28, 2005

(54) Operation mode switching method and apparatus for ensuring ultra low power consumption

(76) Inventors: Tien-Hsin Chang, Taipei (TW); Yung-Sheng Chiu, Taipei (TW)

Correspondence Address: BIRCH STEWART KOLASCH & BIRCH, PO BOX 747, FALLS CHURCH, VA, 22040-0747, US

(21) Appl. No.: 10/691,608

(22) Filed: Oct. 24, 2003

(51) Int. Cl. G06F 1/26

(52) U.S. Cl. 713/323

(57) ABSTRACT

An operation mode switching apparatus for ensuring ultra low power consumption, comprising: a control unit, a clock and a timing device. Wherein, the control unit is used for receiving command signal so as to output a first control signal, a second control signal and an operation mode control signal. The clock is used for receiving the first control signal and use thereof to determine whether a clock signal should be generated for the control unit. The timing device is used for receiving the second control signal and use thereof to determine whether a timing signal should be outputted for the control unit to use.

### BACKGROUND OF THE INVENTION

(a). Field of the Invention

The present invention relates to an operation mode switching method and apparatus, more particularly, to a method and an apparatus for ensuring ultra low power consumption during special protocol cycle.

(b). Description of the Prior Arts

In the field of wireless communication, there are many protocols that are specifically used for power management. For example, one of the specified protocols used for power management in wireless local area network (WLAN) is “Beacon”. That is, while connected, a communication station used in the VLAN can be place in a power-saving, “sleep” or standby mode between beacons, those instants in time when the station looks for information from the WLAN access point (AP). Beacons are transmitted at precise intervals, 10 times per second for example, and are used by the WLAN to identify all network members, and to alert these stations when data is waiting to be transmitted to them. This ability for the communication stations to enter a sleep mode allows a major reduction in power consumption.

Taking this concept a step further, the station does not have to be awake for every beacon. The “Beacon” protocol allows the station to use a parameter called the listen interval to save additional power. The Listen Interval is a parameter sent to the AP during network connectivity. The use of longer Listen Intervals allows the station to miss a specific number of beacons, without losing any data traffic or disconnecting from the network.

Under the mechanism, the AP buffers data, i.e. buffered traffic, while the station is asleep and not listening. For instance, the Listen Interval can be set at 10 so that the station would wake up to listen to every tenth beacon. Therefore, when 10 beacons occur per second, the station would wake and listen once every second. However, It is importance to note that the AP and network must be able to handle data-buffering requirements for all associated devices. In this regard, the longer the Listen Interval is being set, the more power will be saved.

General speaking, every station has a so-called power management apparatus that usually is an apparatus having function of operation mode switching. Therefore, the station can switch into another operation mode that is different from the current operation mode after receiving a specified communication protocol using the foregoing operation mode switching apparatus.

Please refer to FIG. 1, which is a diagram showing an apparatus having function of operation mode switch of a work station according to the prior art. The operation mode switching apparatus 100 of FIG. 1 comprises: a programmable control unit 110 and a high accuracy clock 120.

When the programmable control unit 110 receives a command signal 130 containing a special protocols event, the programmable control unit 110 will issue an operation mode control signal 140 to the working platform 150 inside a work station so that the platform 150 can proceed with mode switching.

In another word, if the command signal 13 received by the programmable control unit 110 indicates the command of “go to sleep”, the programmable control unit 110 will command the working platform 150 to enter the speed mode by issuing the operation mode control signal 140.

Moreover, the duration of the working platform 150 remaining in the sleep mode is depended on the amount of special protocols events contained in the command signal 130. The more the amount of special protocols events are, the longer the working platform 150 will remain in the sleep mode.

Thus, when the programmable control unit 110 acquires the amount of time that the working platform 150 will remain in sleep mode from the amount of special protocols events contained in the command signal 130, the duration of the working platform 150 staying in the sleep mode is controlled by the programmable control unit 110 using clock signals 160 generated by the high accuracy clock 120.

Since the high accuracy clock 120 is used for providing clock ticks to the devices inside the work station, including the programmable control unit 110, before the working platform 150 enters the sleep mode, the high accuracy clock 120 should be a complex apparatus with high power consumption so as to be able to provide clock ticks with high accuracy.

In this regard, even after the working platform 150 of the work station had entered the sleep mode using the operation mode switching apparatus 100, the power consumption is still high because the high accuracy clock 120 inside the apparatus 100 is still in usage. Therefore, the object for entering into the sleep mode is failed.

Hence, the present invention provides an operation mode switch apparatus for ensuring ultra low power consumption while the work station is in sleep mode, or power-save mode, or standby mode.

### SUMMARY OF THE INVENTION

The primary object of the present invention is to provide an operation mode switching apparatus for ensuring ultra low power consumption, the apparatus comprising: a control unit, a clock and a timing device. Wherein, the control unit can receive command signals and output a first control signal, a second control signal and an operation mode control signal. The clock can receive the first control signal and use thereof to determine whether a clock signal should be generated for the control unit. The timing device can receive the second control signal and use thereof to determine whether timing signals should be outputted for the control unit to use.

In a preferred embodiment of the present invention, the timing device is composed of an oscillator and a counter, wherein the counter is used for receiving the second control signal and use thereof along with the counting of the oscillator to output a timing signal.

Another object of the present invention is to provide an operation mode switching method for ensuring ultra low power consumption, which is used for switching the operation mode of the working platform of a work station, the method comprising: when the working platform enters the second operation mode, only a timing device is used for timing the period that the working platform is remaining in the second operation mode.

Yet, when the working platform enters the first operation mode, only the high accuracy clock is used for providing clock to the working platform which is in the first operation mode.

In a preferred embodiment of the present invention, the operation mode switching method for ensuring ultra low power consumption further comprises: when the time for the working platform to remain in the first operation mode is up, the working platform will be switched from the first operation mode to the second operation mode. Moreover, while the working platform enters the first operation mode, the timing device will be activated and the high accuracy clock will be deactivated, on the contrary, while the working platform enters the second operation mode, the high accuracy clock will be activated and the timing device will be deactivated.

To sum up, the present invention provides an operation mode switch apparatus for ensuring ultra low power consumption while the work station is in sleep mode, or power-save mode, or standby mode.

### BRIEF DESCRIPTION OF THE DRAWINGS

FIG. 1 is a block diagram showing an apparatus having function of operation mode switch inside a work station according to the prior art.

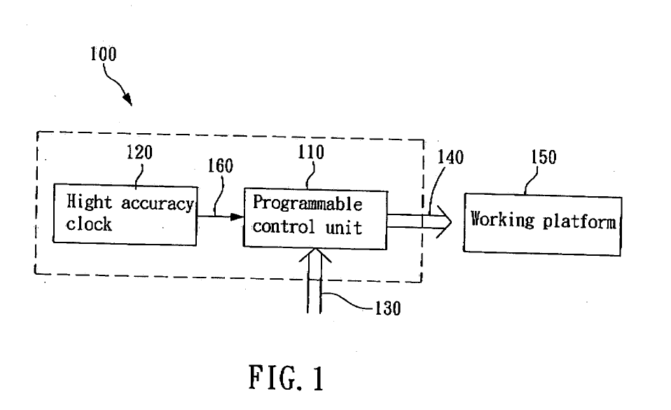

FIG. 2 is a block diagram showing an apparatus having function of operation mode switch according to a preferred embodiment of the present invention.

FIG. 3 is a flowchart showing an operation mode switch method for ensuring low power consumption according to a preferred embodiment of the present invention.

### DETAILED DESCRIPTION OF THE PRESENT INVENTION

Since even after the work station had entered the sleep mode using the operation mode switching apparatus of the prior art, the power consumption is high because the high accuracy clock inside the operation mode switch apparatus is still in usage for time keeping. Therefore, the objective for entering into the sleep mode is failed.

Therefore, the prevent invention adopts different timing device with lower power consumption for timing, instead of using the high accuracy clock originally used for providing clock in the work station. Nevertheless, a timing device with a lower accuracy can be used under the circumstances that it can conform to the timing requirement of the operation mode switch apparatus.

The objects, spirits and advantages of the preferred embodiments of the present invention will be readily understood by the accompanying drawings and detailed descriptions, wherein:

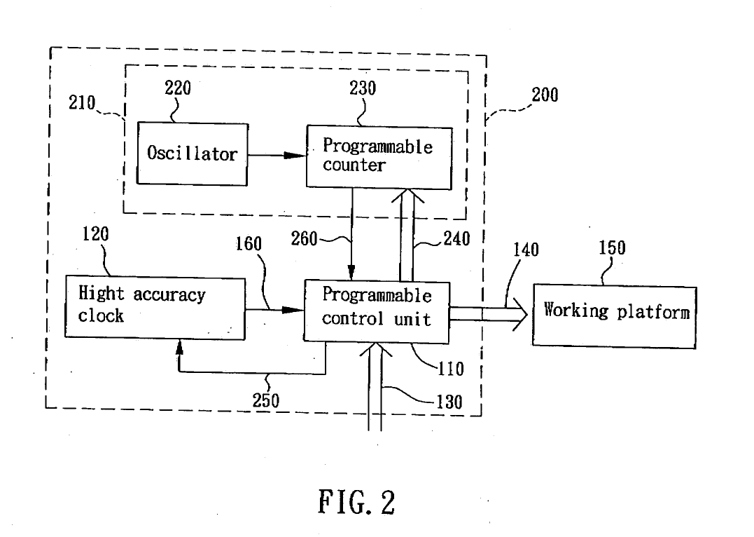

Please refer to FIG. 2, which is a block diagram showing an apparatus having function of operation mode switch according to a preferred embodiment of the present invention. As seen in FIG. 2, the operation mode switch apparatus 200 not only comprises a programmable control unit 110 and a high accuracy clock 120, but also comprises a timing device 210 which is used for time keeping after the working platform 150 in the work station (not shown) is controlled by the apparatus 200 to enter the sleep mode.

In a preferred embodiment of the present invention, since the sleep mode requires longer clock period that is far larger than the clock period provided by the high accuracy clock, the timing device 210 is composed only using a programmable counter 230 and an oscillator 220 having a longer clock period.

The operation principle of the operation mode switch apparatus 200 for ensuring low power consumption is described as following:

When the programmable control unit 110 receives a command signal 130 containing special protocols events, the programmable control unit 110 will issues an operation mode control signal 140 to the working platform 150 intended for mode switching according to the operation mode, such as sleep mode, indicated by the command signal 130 for controlling the working platform 150 to enter the sleep mode.

Simultaneously, the programmable control unit 110 also issues a control signal 240 for enabling the programmable counter 230 to receive and count the long-period clock provided by the oscillator 220 so as to issue a timing signal 250, wherein the timing signal 250 will “remind” the programmable control unit 110 to control the duration of time that the working platform 150 is in the sleep mode in accordance to the special protocols events contained in the command signal 130.

While the programmable control unit 110 is issuing the control signal 240 to enable the programmable counter 230, the programmable control unit 110 is also issuing a control signal 250 for deactivating the high accuracy clock 120 so that the high accuracy clock 120 will no longer output the timing signal 160 which is sent to the programmable control unit 110 before the platform enters the sleep mode.

Therefore, when the programmable control unit 110 receives the command signal 130 and thereafter control the working platform 150 to enter the sleep mode, the programmable control unit 110 simultaneously will deactivate the high accuracy clock 120 and activate the timing device 210 so that the programmable control unit 110 will only accept the timing signal 260 provided by the timing device 210 for controlling the “sleeping time” of the working platform 150.

When the programmable control unit 110 receives a command signal 130 containing special protocols events indicating a wake-up mode, the programmable control unit 110 will issues a operation mode control signal 140 to the working platform 150 for changing the working platform 150 from the sleep mode to the wake-up mode.

Moreover, when the working platform enters the wake-up mode, the same time that the control signal 240 issued by the programmable control unit 110 will deactivate the timing device 210, and also the control signal 250 issued by the programmable control unit 110 will activate the high accuracy clock 120 for providing clocks needed for the working platform 150 after the platform 150 is in wake-up mode.

Thus, when the programmable control unit 110 receives the command signal 130 and thereafter control the working platform 150 to enter the wake-up mode, the programmable control unit 110 simultaneously will deactivate the timing device 210 and activate the high accuracy clock 120 so that the programmable control unit 110 will only accept the timing signal 160 provided by the high accuracy clock 120 for controlling the clock needed for the working platform 150 after the platform 150 is in wake-up mode.

In this regard, while the working platform is switching between different operation modes, the programmable control unit controlling the function of mode switch will generate different control signals for the different operation mode accordingly, for example, the timing signal 260 provided by the timing device 210 for the sleep mode, the timing signal 160 provided by the high accuracy clock 120 for the wake-up mode. Therefore, the operation mode switch apparatus 200 composed of the programmable control unit 120, the high accuracy clock 120 and the timing device 210 will use the timing device 21 of low power consumption for timing, instead of using the high accuracy clock 120 of high power consumption for timing.

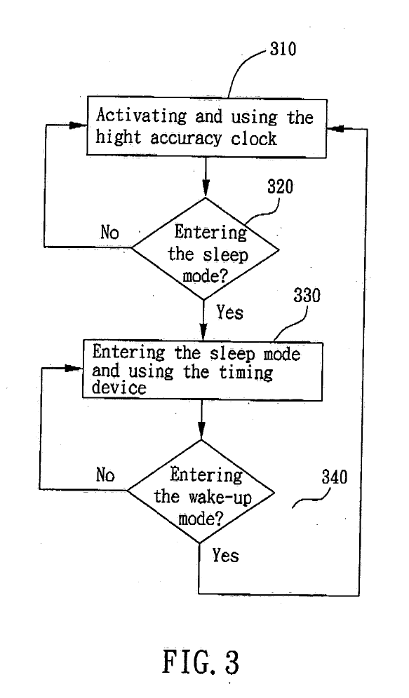

Besides, basing on the forgoing concept, the present invention further provides an operation mode switch method for ensuring low power consumption that is used for operation mode switching. Please refer to FIG. 3, which is a flowchart showing an operation mode switch method for ensuring low power consumption according to a preferred embodiment of the present invention. As seen in FIG. 3, general speaking, while a work station is powered on, the work station will be in the wake-up mode for working normally and use the high accuracy clock for timing with reference to step 310.

Also, the work station will determine which mode to enter, such as the sleep mode basing the received special protocol event, as shown in step 320.

If the received special protocol event indicates entering the sleep mode, the work station will switch from the wake-up mode to the sleep mode, moreover, for conserving the power used while the work station entering the sleep mode, the work station uses a simple timing device for timing the “sleeping time” of the work station, as shown in step 330.

In the step 330, if the work station does not receive a special protocol event indicating the sleep mode, the procedure return to step 300 that the work station is in wake-up mode and uses the high accuracy clock for timing.

If the work station enters the sleep mode in step 330, the station will be waken after receiving a special protocol event indicating the wake up mode, as shown in step 340. Wherein, the special protocol event indicating the wake up mode not only can come from the outside world, but also can be the time out signal coming from the timing device. Hence, the work station in the sleep mode will enter the wake-up mode according to the wake-up protocol coming from the outside world, or according to the end of the “sleeping time”.

To sum up, the present invention provides an operation mode switching method and apparatus for ensuring ultra low power consumption, wherein the apparatus will use a timing device for timing while operating in the sleep mode, and a high accuracy clock for providing clocks while operating in the wake-up mode. Hence, when the work station is in the sleep mode, the timing device of low power consumption will be used, instead of using the high accuracy clock, so that power consumption can be saved.

Those skilled in the art should appreciate that they can readily use the disclosed conception and specific embodiments as a basis for designing or modifying other structures for carrying out the same purpose of the present invention, and that various changes, substitutions and alterations can be made herein without departing from the spirit and scope of the invention as defined by the append claims.

1. An operation mode switch apparatus for ensuring low power consumption, comprising:
a control unit, for receiving a command signal so as to output a first control signal, a second control signal and a operation mode control signal;
a clock, for receiving the first control signal so as to make an evaluation to determine whether a clock signal should be generated for the control unit; and
a timing device, for receiving the second control signal so as to make an evaluation to determine whether a timing signal should be outputted for the control unit to use.

2. The operation mode switch apparatus for ensuring low power consumption of claim 1, wherein the timing device further comprising:
an oscillator, for outputting an oscillating signal; and
a counter, for receiving the second control signal and use thereof along with a counting of the oscillating signals to output the timing signal.

3. The operation mode switch apparatus for ensuring low power consumption of claim 2, wherein the clock signal is a high accuracy clock signal.

4. An operation mode switching method for ensuring ultra low power consumption, which is used for switching the operation mode of the working platform of a work station, the method comprising:
using only a timing device for timing the period that the working platform is in a second operation mode, when the working platform enters the second operation mode; and
using only a high accuracy clock for providing clock to the working platform in the first operation mode, when the working platform enters the first operation mode.

5. The operation mode switch method for ensuring low power consumption of claim 4, the method further comprising:
switching the working platform from the first operation mode to the second operation mode, while the time for the working platform to remain in the first operation mode is up.

6. The operation mode switch method for ensuring low power consumption of claim 5, the method further comprising:
activating the timing device and deactivating the high accuracy clock, while the working platform entering the first operation mode.

7. The operation mode switch method for ensuring low power consumption of claim 6, the method further comprising:
activating the high accuracy clock and deactivating the timing device, while the working platform entering the second operation mode

8. The operation mode switch method for ensuring low power consumption of claim 7, the method further comprising:
activating the timing device and deactivating the high accuracy clock, when the time for the working platform to remain in the first operation mode is up.

9. The operation mode switch method for ensuring low power consumption of claim 8, wherein the first operation mode is a sleep mode.

10. The operation mode switch method for ensuring low power consumption of claim 9, wherein the second operation mode is a wake-up mode.

11. The operation mode switch method for ensuring low power consumption of claim 4, wherein the first operation mode is a power-save mode.

12. The operation mode switch method for ensuring low power consumption of claim 4, wherein the first operation mode is a standby mode.
